(19) United States
(12) Patent Application Publication
(10) Pub. No.: US 2003/0000134 A1
(43) Pub. Date: Jan. 2, 2003

(54) Thermoplastic film having improved anti-fog and mechanical properties

(76) Inventor: Patrick M. N. Vibien, Aurora (CA)

Correspondence Address: MANELLI DENISON & SELTER, 2000 M STREET NW SUITE 700, WASHINGTON, DC, 20036-3307, US

(21) Appl. No.: 09/881,773

(22) Filed: Jun. 18, 2001

(51) Int. Cl. A01G 13/02

(52) U.S. Cl. 47/29.4

(57) ABSTRACT

A composition for use in an agricultural film, comprising a polyolefin in a mixture with an anti-fog effective amount of a polyoxypropylene glycerol stearate. Preferably the film has about 40% w/w of a low density polyethylene, about 40% w/w linear low density polyethylene, about 10% w/w EVA and about 2% w/w the polyoxypropylene glycerol stearate additive. The film has improved anti-fog properties and physical properties of tensile strength and tear properties.

### FIELD OF THE INVENTION

This invention relates to thermoplastic agricultural films, particularly greenhouse films, having improved mechanical properties, such as tensile and tear strengths and, particularly, anti-fog properties; and compositions from which said films are made.

### BACKGROUND OF THE INVENTION

A greenhouse by its very nature is required to be closed during cold periods to contain the heat to create its growing environment. At high humidity inside the greenhouse, water condenses on the inside of the greenhouse roof or cover when the temperature of the roof or cover is reduced to the dew point or lower.

One characteristic of a thermoplastics greenhouse film, in a humid greenhouse environment, is that the water condensate forms on the surface of the film as fine droplets. This condition is known as “fogging” and creates three basic problems for the grower. First, the transmission of sunlight, an essential requirement for plant growth is reduced. Second, the fine droplets coalesce to form larger droplets, which fall onto and may damage the crop below. The damage to the crop may be to the extent that the market value based on crop quality is reduced, and in the case of a specialty crop such as flowers, the damage can render the crop unmarketable. Third, the droplets can act as lenses which focus the light onto the crop resulting in bums to the plants and/or fruit.

One way to overcome the above problem of fogging is to spray the surface of the film exposed in the greenhouse environment with a substance, which when, dry forms a coating which increases the surface tension of the film surface so as to reduce the interfacial tension between the surface and water condensate. The result is that the water vapour condensate wets the film with a clear sheet of water. The water then runs continually down the curvature of the film, instead of the water droplets “raining” down upon the crop below. The enhanced transmission of light increases the crop growth while preventing crop damage. An additional advantage to forming a sheet of water is the insulation effect that it has on the greenhouse. The water sheeting has been shown to provide reductions in the required heating load by upwards of 25%.

However, one problem encountered with the aforementioned spraying of the greenhouse film is that the sprayed substance may itself be harmful to the crop. Although reasonable steps are generally taken to protect the crop during the spraying operation, even with the most careful of application techniques some crop damage is inevitably experienced.

In addition, because the coating substance is sprayed as a solution and the mixing process is generally critical and requires the use of distilled water and/or pH balance control, care by growers must be taken. Further, for successful application the film must be dry, and sunlight to dry the coating is necessary. The grower must not only take great care but must also await the proper weather and time of day to apply the solution.

It can thus be seen that an anti-fog system that does not require the labour intensive spraying of “in-house” film offers an advantage to growers.

Another method used to overcome the anti-fogging problem involves the incorporation of surfactants into the plastics matrix by the manufacturers of the greenhouse film wherein the surfactant “blooms” to the inner surface of the greenhouse covering, i.e. there is a slow release of the surfactant to the film surface over time. In use, the surfactant reduces the interfacial tension between the surface and the water condensate. The result is that the water vapour condensate wets the film with a clear sheet of water. Unfortunately, in the prior art films the efficacy, of the anti-fog properties of the film drops off over time.

Thus, there is a need for a film having an extended effective, greenhouse, anti-fog property lifetime over that given by commercially available greenhouse films.

### SUMMARY OF THE INVENTION

It is an object of the present invention to provide a greenhouse having a roof covering of a thermoplastic film having anti-fog properties of improved effectiveness and improved mechanical properties.

It is a further object of the invention to provide said thermoplastic film having said improved properties.

It is a yet further object to provide a composition of use in the manufacture of said thermoplastic film.

These and other objects of the present invention will be seen from a reading of this specification as a whole.

Accordingly, the invention provides, in one aspect, a composition comprising a polyolefin in a mixture with an anti-fog effective amount of a polyoxypropylene glycerol stearate.

By the term “polyolefin” as used in this specification and claims is meant the polyethylene, polypropylene and polybutadiene family of olefin polymers and copolymers. As examples, high density, low density and linear low density polyethylenes and 1,2-polybutadienes may be mentioned. The term “polyethylene” includes (a) ethylene homopolymers, (b) copolymers of ethylene with vinyl acetate, acrylic acid, methyl methacrylate, butene, n-hexane, 4-methyl-1-pentene and octene, and (c) blends of (a) and (b).

In preferred compositions and films made therefrom according to the invention, low density and linear low density polyethylene are present in approximately the same amounts to total significantly more than, optionally present, EVA. Typical composition ranges are 0-55% w/w low density polyethylene, 30-96% linear low density polyethylene and 3-15% EVA.

Preferably, the polyolefin is selected from low density and linear low density polyethylenes.

The amount of additive in the polymer matrix is preferably selected from 0.1-5% w/w, and more preferably 1-3% w/w.

A most preferred stearate additive is “Crovol PGS ”™ stearate manufactured by Croda International.

In a further aspect, the invention provides a thermoplastic film formed of a composition as hereinbefore defined.

The aforesaid composition per se, when used, for example, as a single layer or sheet as a roof covering of a greenhouse offers an external surface of improved wetting property and an internal surface providing improved anti-fog characteristics over an unexpected beneficial period of time.

In alternative embodiments, the aforesaid composition according to the invention may be used as part of a multi-layered film constituted as comprising (a) a plurality of distinct layers constituted as a plurality of distinct piles, (b) a laminate comprising at least two distinct films or piles adhered to each other, directly, or by means of an adhesive, (c) a co-extruded film produced by the self-adhesion of two or more films to each other under hot process conditions or (d) a co-oriented film, laminate or ply made by the cold drawing of a plurality of thermoplastic films, simultaneously in such close contact together that under the drawing step at the drawing temperature the films become intimately associated and unified into a single resultant film or ply while each undivided film is being uni-axially oriented. However, it should be readily understood that the innermost surface layer used in the greenhouse must be formed of the composition according to the invention to provide the improved anti-fog properties.

Thus, the nature of the second and, optionally, other layers of the multiplayer film of use in the practice of the invention may be suitably selected by the skilled artisan based on the usual desired properties such as weight, ease of manufacture, durability, resistance to sunlight, and the like. It will be, thus, clear that the choice of olefinic material of such subordinate layers is not crucial to this invention and resides within the skill in the art. Preferably, the subordinate layer is formed of at least one polyolefin.

The aforesaid films according to the invention may be, preferably, further stabilized for multiyear service life in a greenhouse environment. Stabilization additives include, for example, antioxidants, UV stabilizers, UV absorbers and chelating agents in the quantities required for their specific application. In addition, the films may contain additives to give light diffusion, alteration of sunlight spectrum, infra-red energy conservation, and barrier properties.

The films as described aforesaid may be readily made by aforesaid processes known in the art, preferably by blown film extrusion. Film widths range, typically, from 1 m to 20 m with three to five layered co-extruded films being most preferred. The said layers are composed of LDPE, LLDPE or EVA copolymer blends.

The film according to the invention is installed and laid to cover the covering supports of a greenhouse structure as is conventional in the art, but with a surface of the film comprising the composition according to the invention on the inside of the greenhouse. The humidity within the greenhouse condenses on this surface to form a clear sheet of condensate. Freshly installed film takes less than 24 hours to equilibrate with the humid greenhouse atmosphere and become wetted. The anti-fog action of this film is efficaciously long lasting in its anti-fogging effect, since there are no sprayed coatings to be bleached away.

Surprisingly, I have discovered that the films, according to the invention, have additional improved physical properties of improved tensile strength and tear properties. The improved tensile strength, particularly in the machine direction of manufacture, allows the film to receive a greater stress and force once installed on the greenhouse. Significant increases in both the machine and transverse direction tear values allows of easier installation of the films onto the greenhouse while offering more resistance to tearing the length of the greenhouse if a tear is initiated by an external means.

### BRIEF DESCRIPTION OF THE DRAWINGS

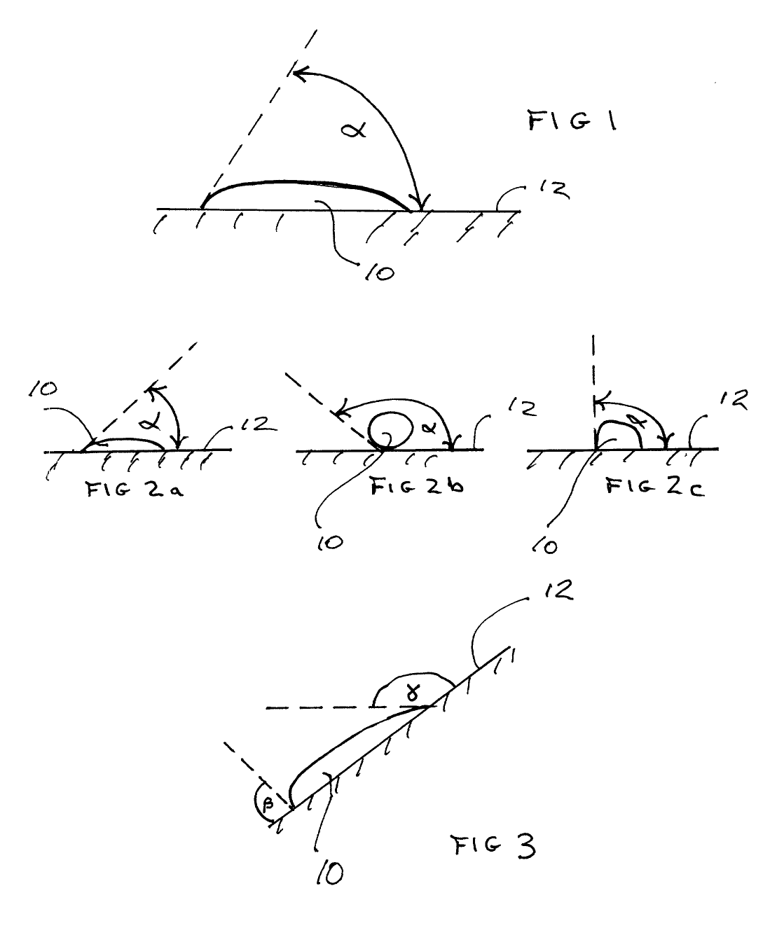

In order that the invention may be better understood preferred embodiments will now be described by way of example only, with reference to the accompanying examples and drawings wherein: FIG. 1 is a diagrammatic representation of a liquid droplet on a film surface showing a contact angle α; FIGS. 2a-2c show a diagrammatic representation of the differences between a highly wetted, a non-wetted and a borderline wetted liquid/substrate interface, respectively; FIG. 3 is a diagrammatic representation of an advancing and a receding contact angle formed by a water droplet on a tilted substrate film surface, and wherein the same numerals denote like parts.

### DETAILED DESCRIPTION OF PREFERRED EMBODIMENTS

A most preferred polyoxypropylene glycerol stearate of use in the practice of the invention is aforesaid “Crovol PGS”™ stearate and has the physical properties, shown in Table 1.

TABLE 1

“Crovol PGS” ™ Stearate

| Property | Sample 1 | Sample 2 |
|---|---|---|
| Appearance | White solid | White/pale yellow solid |
| Colour | <1 | 1+ |
| DSC* Melting Point | 35.1° C. | 35.1° C. |
| Acid Value | 0.6 | 0.9 |
| Hydroxyl Value | 198.9 | 201.1 |
| Saponification Value | 147.8 | 139.3 |

*Differential Scanning Calorimeter

The aforesaid stearate (1) is preferably compounded with the polyolefin into a masterbatch to provide a composition which is subsequently blown or extruded into a film. A most preferred polyolefin is a mixture of low density and linear low density polyethylene.

With reference to the Figures, these show a water droplet (10) on a surface (12) of a film according to the invention, providing a contact angle α and an advancing contact angle β and a receding contact angle γ.

The static contact angle α is a physical measurement used to describe how a liquid droplet sits on the surface of a solid substrate and is the angle of the liquid droplet when the substrate is at a constant horizontal position as shown in FIG. 1.

Any liquid/substrate combination that has a contact angle of less than 90° is said to “wet out” or be “wetting”. Any combination with a contact angle of greater than 90° is said to be “non-wetting”. For the purposes of an anti-fog film according to the invention, water is the liquid and the polymer film is the solid substrate. The lower the contact angle for this combination, the better the anti-fog properties of the film. FIGS. 2a, 2b and 2c demonstrate the difference between a highly wetted, a non-wetting and border-line wetting liquid/solid interface, respectively.

In addition to the static contact angle, the substrate film may be tilted to an angle of 45° , which simulates the conditions of a greenhouse roof. This allows the measurement of the advancing and receding contact angles for the same combination of liquid/substrate. The advancing contact angle is the angle the liquid makes with the substrate at the liquid drop's leading edge, whereas the receding contact angle is the angle the liquid makes with the substrate at the trailing edge of the droplet. The advancing contact angle is illustrated in FIG. 3.

The importance of the advancing contact angle is identical to that of the static contact angle. The lower the value of angles the better the liquid/substrate combination is to wet and the better anti-fog properties the film will have.

Table 2 provides comparative static, advancing and receding contact angles for a variety of anti-fog films for their respective inner layers. Film A is an anti-fog film according to the invention which illustrates the improvements in anti-fog properties over Film B, a currently available commercial LDPE/LLDPE anti-fog film. Film C, a commercially available EVA film, often referred to in the marketplace as the preferred anti-fog film is included for comparison. Also included are Film D and Film E, not according to the invention. Numbers after the indicated film types indicate different samples of the same film that were tested (indicated as a Sub-Sample).

The anti-fog additive X present in Film B is a glyceride fatty acid ester commercially available from Uniqema. From testing and analysis, the anti-fog additive Y in Films C and D is suspected to be a propoxylated glycerol fatty acid ester which is present in the commercially available “ESCORENE AG0160”™ EVA based resin (EXXON). The suspected level of anti-fog additive in Films C and D is approximately 2% w/w.

| | |
|---|---|
| Polyethylene | Composition |

Composition of Film A:

| | |
|---|---|
| Low Density | 43% |
| Linear Low Density | 44% |
| EVA | 10.7% |
| “CROVOL PGS” ™ Additive | 2.3% |

Composition of Film B:

| | |
|---|---|
| Low Density | 44% |
| Linear Low Density | 46% |
| EVA | 8.2% |
| Fatty Acid Ester Anti-Fog Additive X | 1.8% |

Composition of Film C:

| | |
|---|---|
| Low Density | 0% |
| Linear Low Density | 13% |
| EVA | 85% |
| Fatty Acid Ester Anti-Fog Additive Y | 2% |

Composition of Film D:

| | |
|---|---|
| Low Density | 3% |
| Linear Low Density | 0% |
| EVA | 95% |
| Fatty Acid Ester Anti-Fog Additive Y | 2% |

Composition of Film E:

| | |
|---|---|
| Low Density | 35% |
| Linear Low Density | 65% |
| EVA | 0% |
| Anti-fog Additive | 0% |

TABLE 2

| Sample | Sub-Sample | Static (α) | Advancing (β) | Receding (γ) |
|---|---|---|---|---|
| A | 1 | 36.1 ± 3.9 | 47.4 ± 2.1 | <10 |
| | 2 | 44.5 ± 3.1 | 57.6 ± 2.6 | <10 |
| | 3 | 44.2 ± 1.3 | 59.3 ± 1.5 | <10 |
| B | 1 | 69.9 ± 1.6 | 90.3 ± 2.2 | 12.2 ± 2.9 |
| C | 1 | 11.0 ± 1.0 | 30.7 ± 2.3 | <10 |
| D | 1 | 59.1 ± 2.1 | 80.1 ± 5.0 | <10 |
| E | 1 | 104.7 ± 7.6 | 114.6 ± 4.9 | 84.8 ± 3.9 |

TABLE 3

| Film Property | Film A | | | Film B |
|---|---|---|---|---|
| Sub-Sample | 1 | 2 | 3 | 1 |
| Gauge-mil (μm) | 6.0 | 6.0 | 6.0 | 6.0 |
| | (150) | (150) | (150) | (150) |
| Tensile-Machine Direction | | | | |
| 22% Stress (MPa) | 10.6 | 10.4 | 10.7 | 11.2 |
| Max Stress (MPa) | 23.7 | 25.3 | 26.8 | 27.6 |
| 22% Force (N) | 42.6 | 43.4 | 40.6 | 43.7 |
| Max Force (N) | 99.98 | 105.4 | 101.7 | 107.1 |
| Elongation (%) | 596 | 660 | 652 | 632 |
| Break Energy (J) | 19.3 | 21.5 | 20.2 | 22.4 |
| Tensile-Transverse Direction | | | | |
| 22% Stress (MPa) | 10.8 | 10.7 | 10.4 | 11.0 |
| Max Stress (MPa) | 23.2 | 23.1 | 23.9 | 25.4 |
| 22% Force (N) | 42.2 | 44.9 | 37.9 | 39.9 |
| Max Force (N) | 90.5 | 96.8 | 86.9 | 92.2 |
| Elongation (%) | 726 | 716 | 696 | 736 |
| Break Energy (J) | 18.5 | 20.2 | 17.3 | 19.2 |
| Tear-Machine Direction (N) | 5.6 | 8.7 | 11.9 | 8.6 |
| Tear-Transverse Direction (N) | >32 | 28.5 | 27.5 | 20.4 |

TABLE 4

| Film Property | Film C | Film D | Film E |
|---|---|---|---|
| Sub-Sample | 1 | 1 | 1 |
| Gauge-mil (μm) | 6.0 | 6.0 | 6.0 |
| | (150) | (150) | (150) |
| Tensile-Machine Direction | | | |
| 22% Stress (MPa) | 9.8 | 6.7 | 12.6 |
| Max Stress (MPa) | 24.0 | 21.8 | 33.3 |
| 22% Force (N) | 34.9 | 25.0 | 48.6 |
| Max Force (N) | 84.9 | 81.7 | 125 |
| Elongation (%) | 484 | 566 | 684 |
| Break Energy (J) | 13.4 | 14.0 | 24.9 |
| Tensile-Transverse Direction | | | |
| 22% Stress (MPa) | 9.3 | 6.8 | 12.9 |
| Max Stress (MPa) | 23.0 | 21 | 31.9 |
| 22% Force (N) | 33.4 | 25.4 | 47.6 |
| Max Force (N) | 82.6 | 78.4 | 118 |
| Elongation (%) | 620 | 544 | 776 |
| Break Energy (J) | 14.5 | 12.2 | 24.1 |
| Tear-Machine Direction (N) | 3.5 | 5.8 | 10.2 |
| Tear-Transverse Direction (N) | 10.3 | 8.0 | 30.2 |

With reference to the results in Table 2, Film A, according to the present invention shows significantly improved anti-fog properties over Film B. In addition, Film A shows improved anti-fog properties over Film D, an EVA based film. Although Film C has improved anti-fog properties over Film A, it is achieved at the expense of inferior mechanical properties.

The film properties shown in Tables 3 and 4 of were measured according to ASTM standards as follows: Film—Gauge ASTM D2104; Film—Tensile Properties (MD and TD) ASTM D822 and Film—Tear (MD and TD) ASTM D1922.

With reference to the results in Tables 3 and 4, these show that Film A, according to the present invention (low density/linear low density polyethylene formulation) has significantly improved tensile values to that of commercially available EVA based Films C and D. Furthermore, the physical improvements imparted by using linear low density polyethylene over an EVA resin have resulted in Tear Properties of Film A being nearly double than those for Films C and D.

ANTI-FOG TANK TESTS

Another method of assessing the quality and longevity of an anti-fog film's performance is the installation of the film onto a fog tank. Each fog tank consists of a polymer film inclined at an angle with one surface exposed to a humid environment maintained by the continuous running of hot water at a desired temperature. This test serves as an accelerated, qualitative measure of the anti-fog films performance.

Visual results showed that after 20 days of exposure Film A according to the invention formed an excellent sheet of water on the inner film surface.

The film after 56 days of exposure still exhibited very good wetting action from a very good sheet of water on the film and provided good light transmission.

In comparative tests against commercial Film B over a 15 month period, Film A had formed a better sheet of water on the films inner surface, indicative of better anti-fog action.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. A composition for use in an agricultural film, said composition comprising a polyolefin and an anti-fog effective amount of a polyoxypropylene glycerol stearate.

2. A composition as defined in claim 1 wherein said polyolefin is selected from the polyethylene, polypropylene and polybutadiene family of olefin polymers and copolymers.

3. A composition as defined in claim 2 wherein said polyethylene is selected from ethylene homopolymers and copolymers thereof.

4. A composition as defined in claim 3 wherein said copolymer comprises copolymers of ethylene with vinyl acetate, acrylic acid, methyl methacrylate, butene, n-hexane, 4-methyl-1-pentene and octene and blends thereof.

5. A composition as defined in claim 3 wherein said ethylene homopolymer is selected from a low density polyethylene and a linear low density polyethylene.

6. A composition as claimed in claim 5 comprising 0-55% w/w low density polyethylene, 30-96% w/w linear low density polyethylene and 0-15% w/w EVA.

7. A composition as claimed in claim 6 comprising about 40% w/w low density polyethylene, about 40% w/w linear low density polyethylene, about 10% w/w EVA and about 2% w/w of said polyoxypropylene glycerol stearate.

8. A composition as defined in claim 1 comprising 0.1-5% w/w of said polyoxypropylene glycerol stearate.

9. A composition as defined in claim 8 comprising 1-3% w/w of said polyoxypropylene glycerol stearate.

10. A composition as defined in claim 1 wherein said polyoxypropylene glycerol stearate has a differential scanning calorimeter melting point of about 35° C., an acid value of about 0.7, a hydroxyl value of about 200 and a saponification value of about 145.

11. A greenhouse film having at least one external layer formed of a composition as defined in claim 1.

12. A greenhouse film having at least one external layer formed of a composition as defined in claim 2.

13. A greenhouse film having at least one external layer formed of a composition as defined in claim 3.

14. A greenhouse film having at least one external layer formed of a composition as defined in claim 4.

15. A greenhouse film having at least one external layer formed of a composition as defined in claim 5.

16. A greenhouse film having at least one external layer formed of a composition as defined in claim 6.

17. A greenhouse film having at least one external layer formed of a composition as defined in claim 7.

18. A greenhouse film having at least one external layer formed of a composition as defined in claim 8.

19. A greenhouse film having at least one external layer formed of a composition as defined in claim 9.

20. A greenhouse film having at least one external layer formed of a composition as defined in claim 10.
